(19) United States
(12) Patent Application Publication
(10) Pub. No.: US 2025/0382471 A1
(43) Pub. Date: Dec. 18, 2025

(54) HYBRID EPOXY-POLYSILOXANE ETCH PRIMER AND COATINGS SYSTEMS FORMED THEREFROM

(71) Applicant: SWIMC LLC, Cleveland, OH (US)

(72) Inventors: Liang LIANG, Twinsburg, OH (US); Peter MAASSEN VAN DEN BRINK, Amsterdam (NL); Chaohui ZHOU, Solon, OH (US); Scott T. SMALLEY, Mentor, OH (US); Zhangqing YU, Twinsburg, OH (US); Zhiqi YANG, Solon, OH (US); Travis SMITH, North Royalton, OH (US); Gordon A. BORU, Cleveland, OH (US)

(21) Appl. No.: 19/236,031

(22) Filed: Jun. 12, 2025

Related U.S. Application Data
(60) Provisional application No. 63/659,423, filed on Jun. 13, 2024.

(51) Int. Cl. C09D 5/00; C09D 7/80; C09D 163/10; C09D 183/06

(52) U.S. Cl. CPC C09D 5/002; C09D 7/80; C09D 163/10; C09D 183/06

(57) ABSTRACT

A primer system is provided. The system includes an etch primer including a network of crosslinked epoxy resin regions and crosslinked polysiloxane resin regions. The crosslinked epoxy resin regions include units from an epoxy resin, an aliphatic amine, and one or more first silicon based compounds containing one or more amino or hydroxyl functional groups. The crosslinked polysiloxane resin regions are formed from one or more second silicon based compounds containing one or more amino or hydroxyl functional groups. The first and second silicon based compounds containing one or more amino or hydroxyl functional groups may be the same or different from one another. The crosslinked epoxy resin regions and crosslinked polysiloxane resin regions form the network optionally having the crosslinked epoxy resin regions and crosslinked polysiloxane resin regions crosslinked with one another.

### CROSS REFERENCE TO RELATED APPLICATIONS

The present application is related to, and claims priority to, U.S. Provisional Application Ser. No. 63/659,423, filed Jun. 13, 2024, the contents of which are hereby incorporated by reference in their entirety.

### TECHNICAL FIELD

The present invention relates to a hybrid epoxy-polysiloxane etch primer formed upon a reaction between epoxy resin, aliphatic amine, and one or more silicon based compounds; coatings systems formed therefrom; and methods of making the same.

### BACKGROUND OF THE INVENTION

There is an increasing demand for the development and use of waterborne coatings due to environmental considerations, especially the negative impacts on environment resulting from solvent-borne coating solutions, and particularly the volatile organic compounds (VOC) associated therewith. Solvent borne primers are frequently used in the refinishing of vehicles, which provide improved performance in areas such as anticorrosion. However, the VOC associated with solvent-borne primers is one of the critical issues prompting interest in a switch to waterborne primers.

Low VOC and zero emission are significant advantages of waterborne coatings, providing a motivation to develop various waterborne coating solutions. Many efforts have been addressed to replace solvent-borne primers with waterborne primers. However, past efforts have resulted in poor performance, particularly in the area of anticorrosion, thus restricting the use of waterborne primers, especially for refinishing vehicles and for coating other metal surfaces in particular.

A primer is a paint or coating product that allows finishing paint to adhere to a surface much better than if it were used alone. It is designed to adhere to surfaces and to form a binding layer that is better prepared to receive the paint. Compared to paint, a primer is not typically intended to be used as the outermost durable finish and can instead be engineered to have improved filling and binding properties with the material underneath. Sometimes this can be achieved by chemistry, and others by controlling the primer's physical properties such as its porosity, tackiness, and hygroscopy. Some primers are further defined as etch primers, which may etch the surface to which it is applied to further promote adhesion between the etch primer and the surface.

### SUMMARY OF THE INVENTION

Accordingly, one object of the present invention is to provide hybrid waterborne etch primer compositions that has a combination of properties not otherwise attainable with a single polymer based etch primer.

A further object of the present invention is to provide hybrid waterborne etch primer compositions that can be used as an etch primer for adhesion to substrates, particularly metal substrates.

A further object of the invention is to provide hybrid waterborne etch primer compositions formed upon mixing two parts. The first part comprises epoxy resin, and the second part comprises a mixture of aliphatic amine or linear hybrid epoxy-amine compound and one or more silicon based compounds. The one or more silicon based compounds may comprise amino and/or hydroxyl functional groups. Upon mixing the first part and the second part, a network comprising crosslinked epoxy resin regions and crosslinked polysiloxane resin regions is formed. The waterborne etch primer composition may be applied to substrates, particularly metal substrates, and provides comparable and/or improved adhesion and anti-corrosion properties, among other properties, when compared to conventional solvent borne etch primers.

A further object of the invention is to provide a coatings system over a substrate, particularly a metal substrate, comprising a hybrid epoxy-polysiloxane etch primer layer and a primer layer over the hybrid epoxy-polysiloxane etch primer layer. The primer layer may include a waterborne polyurethane primer layer or a waterborne hybrid epoxy-polyurethane primer layer. The coatings system has a combination of properties not otherwise attainable with a conventional waterborne coating systems.

Another object of the present invention is to provide a method for the production of the hybrid epoxy-polysiloxane etch primer compositions of the present invention, and methods for its use.

These and other objects of this invention, alone or in combination, have been satisfied by the discovery of a hybrid epoxy-polysiloxane etch primer comprising a network of crosslinked epoxy resin regions and crosslinked polysiloxane resin regions. The hybrid epoxy-polysiloxane etch primer and coatings systems made therefrom will be further described in the following detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 illustrates a schematic of some embodiments of a hybrid epoxy-polysiloxane etch primer applied to a substrate, the hybrid epoxy-polysiloxane etch primer comprising a polymer network formed upon a reaction between an epoxy resin, aliphatic amine, and one or more silicon based compounds as described herein.

FIG. 2 illustrates a schematic of some embodiments of crosslinked polysiloxane bonded to a substrate.

FIG. 3 illustrates a schematic of some embodiments of the formation of crosslinked polysiloxane via condensation of silanes.

FIG. 4 illustrates a schematic of some embodiments of a crosslinked epoxy formed from a reaction between an epoxy resin and an aliphatic amine.

FIG. 5 illustrates a schematic of some embodiments of a hybrid epoxy-polysiloxane formed from a reaction between silane and epoxy resin.

### DETAILED DESCRIPTION OF THE INVENTION

The recitation of a numerical range using endpoints includes all numbers subsumed within that range (e.g., 1 to 5 includes 1, 1.5, 2, 2.75, 3, 3.80, 4, 5, etc.).

To the extent that the terms “including”, “includes”, “having”, “has”, “with”, or variants thereof are used in the present application, such terms are intended to be inclusive in a manner similar to the term “comprising.” The singular forms “a”, “an” and “the” include plural referents unless the context clearly dictates otherwise. Additionally, the terms “a,” “an,” “the,” “at least one,” and “one or more” are used interchangeably. Thus, for example, a coating composition that contains “an” additive means that the coating composition can include “one or more” additives. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

The term “comprises” and variations thereof do not have a limiting meaning where these terms appear in the description and claims.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

The term “acrylic” as used herein includes (meth)acrylic acid, (meth)alkyl acrylate, (meth)acrylamide, (meth)acrylonitrile and their modified forms such as (meth)hydroxyalkyl acrylate. Throughout this document, the word fragment “(meth)acryl” refers to both “methacryl” and “acryl.” For example, (meth)acrylic acid refers to both methacrylic acid and acrylic acid, and methyl (meth)acrylate refers to both methyl methacrylate and methyl acrylate.

The term “aliphatic” when used in the context of a carbon-carbon double bond includes both linear (or open chain) aliphatic carbon-carbon double bonds and cycloaliphatic carbon-carbon double bonds but excludes aromatic carbon-carbon double bonds of aromatic rings.

The term “aqueous” composition or dispersion herein means that particles are dispersed in an aqueous medium. An “aqueous medium” herein has a continuous phase of water that makes up at least 50 weight percent of the aqueous medium, wherein the remaining composition of the aqueous medium comprises particles and water-miscible compound(s) such as, for example, alcohols, glycols, glycol ethers, glycol esters, water soluble oligomers and polymers, and the like.

The term “(co) polymer” as used herein includes both homopolymers (polymers containing units from a single monomer) and copolymers (polymers containing units from two or more different monomers), unless otherwise specifically stated. Copolymers also include star, dendritic, block, and grafting polymer.

The term “crosslinker” or “crosslinking component” as used herein refers to at least one molecule capable of forming a covalent linkage between polymers or between two different regions of the same polymer.

The term “on,” when used in the context of a coating applied on a substrate, includes both coatings applied directly or indirectly to the substrate. Thus, for example, a coating applied to a primer layer overlying a substrate constitutes a coating applied on the substrate.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

As used herein, the term “structural units,” also known as polymerized units, of the named monomer refers to the remnant of the monomer after polymerization, or the monomer in polymerized form.

Within the context of the present invention, the term “hybrid primer” includes, but is not limited to, semi- and fully interpenetrating crosslinked networks of two polymer types, blends of two different polymer types that have been chemically bonded either directly or via a linking agent, chemically bonded crosslinked networks of two polymer types, a crosslinked network of one polymer type chemically modified by a compound that then can form its own crosslinked network after bonding to the original crosslinked network, and the like. Crosslinked networks can also be developed by thermal activation, redox reactions, gamma irradiation, and/or UV-irradiation.

Within the context of the present invention, the term “waterborne” is intended to mean that the polymeric components are in an aqueous medium. In certain embodiments, waterborne coatings provide one or more of the following advantages: low toxicity and non-flammability due to low VOC levels and low HAP emissions; lower cost than solvent-borne coatings and no additives, thinners, or hardeners are required in most cases; less coating is required to cover the same surface area as compared to the use of solvent borne coating solutions; and paint guns can be readily cleaned with water or water-based solutions and do not require paint thinner, acetone, or methyl acetate (further environmentally friendly and user safety friendly). Thus, byproducts from cleaning processing equipment used to produce waterborne coatings are also more environmentally and user friendly compared to byproducts from solvent borne coatings.

Within the context of the present invention, the term “substantially unreactive with” is intend to mean that if any reactions did occur after mixing two or more polymers together, then the number of reactions between the polymers are so few and insignificant that the overall viscosity of the mixture remains below 120 Krebs units after being stored for 30 days at 40 degrees Celsius. This viscosity limit indicates that no gelling has occurred, and thus, the resin component is still usable for coating applications with consistent performance properties.

The present invention relates to the formulation of hybrid epoxy-polysiloxane waterborne etch primer coatings, methods used to prepare the etch primer coatings, and their use as coatings on substrates. The hybrid waterborne primers of the invention can be used alone as a direct-to-substrate (or in certain embodiments, direct-to-metal or “DTM”) etch primer or in combination with a surface treatment on the substrate to be coated such as some other chemical surface treatment to render the surface of the substrate better able to receive and bond with the hybrid waterborne etch primer of the invention.

In certain embodiments of the invention, the waterborne hybrid etch primer of the invention is a hybrid epoxy-polysiloxane network having crosslinked epoxy resin regions and crosslinked polysiloxane resin regions. Optionally, the crosslinked epoxy resin regions and the crosslinked polysiloxane resin regions are crosslinked with one another. The hybrid epoxy-polysiloxane etch primer may be waterborne and provides a balance of favorable properties attributable to the crosslinked epoxy resin regions and the crosslinked polysiloxane resin regions (e.g., chemical resistance, mechanical properties, weatherability, cure rates, potlife, anti-corrosion, etc.).

For example, epoxy resins typically demonstrate good chemical and thermal stability, adhesive and mechanical strength, which can be used for anti-corrosion properties. However, epoxy resins often exhibit a high rigidity property, which can reduce the flexibility of a coating formed therefrom, and sanding capability is also a challenge. For example, epoxy resin prepared by bisphenol-A (BPA) has poor anti-UV properties due to many benzene rings in polymer chain. Polysiloxane is a rubber type polymer having more hydrophobic and flexible properties compared with epoxy resins. Polysiloxane typically demonstrates good chemical, thermal, and weathering stability. Thus, the epoxy resin and polysiloxane are combined to form a hybrid etch primer as described herein in order to provide the anticorrosion benefits of the epoxy and the flexibility and hydrophobic properties of the polysiloxane in a single hybrid etch primer composition. The hydrophobic property of polysiloxane provides the capability to prevent penetration of water moisture through the film and the flexibility of polysiloxane chains to offer a softer more flexible property to the final film coated on a substrate, thereby improving overall flexibility of the film, the anti-degradation properties, and overall sanding capability. Further, by using a silicon based compound containing one or more amino or hydroxyl functional groups in providing the polysiloxane based portion of the hybrid etch primer, the hybrid epoxy-polysiloxane etch primer disclosed herein has enhanced adhesive strength with the substrate. Combined with the excellent chemical and thermal stability and mechanical strength of the epoxy resin, the resulting hybrid waterborne epoxy-polysiloxane etch primer of these embodiments exhibit much better performance compared with conventional solvent borne etch primers.

The hybrid epoxy-polysiloxane etch primer may be formed from a two-component (“2K”) system. The 2K system comprises a first part and a second part. The first part comprises an epoxy resin, and the second part comprises an aliphatic amine, a first silicon based compound, and a second silicon based compound. The first silicon based compound and the second silicon based compound, which may be the same or different from one another, may each contain amino and/or hydroxyl groups. The aliphatic amine, the first silicon based compound, and the second silicon based compound are substantially unreactive with one another such that the second part is shelf-stable. In some embodiments, the aliphatic amine comprises an aliphatic hybrid epoxy-amine compound. Upon mixing the first part with the second part, the crosslinked epoxy resin regions are formed at least from a reaction between the epoxy resin, the aliphatic amine, and the first silicon based compound. In particular, curing (or crosslinking) of the epoxy resin is at least based on an opening-ring reaction when the epoxy resin is mixed with aliphatic amines. The first silicon based compound further comprises hydroxyl groups and/or amino groups which can also react with the epoxy resin via an opening-ring reaction.

Additionally, upon mixing the first part with the second part, the crosslinked polysiloxane resin regions are formed at least from the second silicon based compound via condensation reactions and/or reactions with the epoxy resin. Upon applying the mixture of the first part and the second part to a substrate, the second silicon based compounds may also react with the substrate to adhere to the substrate via covalent bonding. As the crosslinking reactions progress upon mixing the epoxy resin, aliphatic amine, first silicon based compound, and second silicon based compound, the crosslinked epoxy resin becomes interlaced with the crosslinked polysiloxane resin. Additionally, at least because the crosslinked polysiloxane resin comprises hydroxyl and/or amino functional groups, crosslinking may occur between the crosslinked epoxy resin and the crosslinked polysiloxane resin.

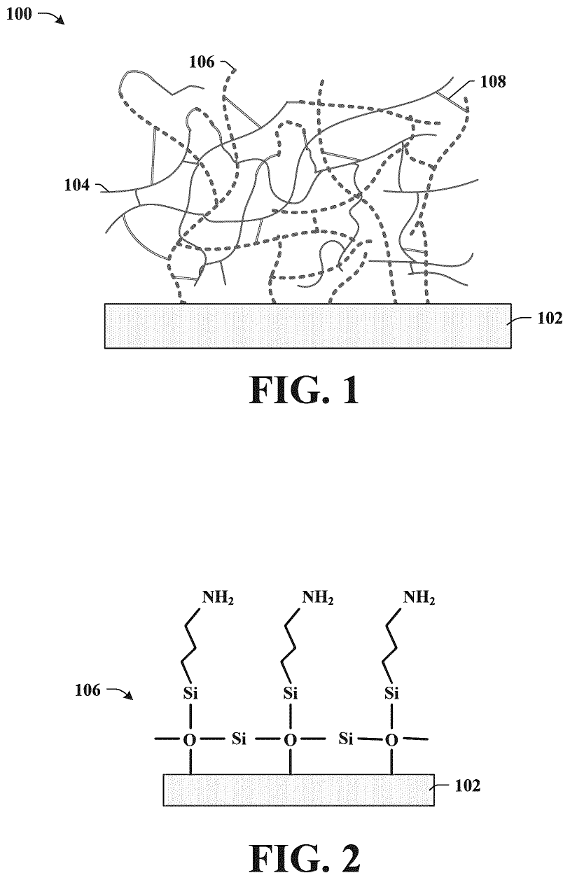

FIGS. 1-5 further help explain the reactions that can be used in preparing various embodiments of the hybrid epoxy-polysiloxane waterborne etch primer.

FIG. 1 presents a schematic of some embodiments of the hybrid epoxy-polysiloxane etch primer formed by a crosslinked polymer network 100 over a substrate 102. The crosslinked polymer network 100 comprises regions of the crosslinked epoxy resin 104 and regions of the crosslinked polysiloxane resin 106, the crosslinked epoxy resin regions 104 being chemically connected with the crosslinked polysiloxane resin regions 106 via crosslinking 108. It will be appreciated while the crosslinking 108 illustrated in FIG. 1 appears to be distinct from the other crosslinked regions 104, 106, the crosslinking 108 actually comprises a combination of the epoxy resin regions 104 and the polysiloxane resin regions 106. Additionally, the relative ratio of epoxy resin regions 104, polysiloxane resin regions 106, and crosslinking 108 in FIG. 1 is simply exemplary and can vary depending on the ratio of reactants used to form the hybrid epoxy-polysiloxane etch primer.

In such a crosslinked polymer network 100, the crosslinked polysiloxane resin 104 and the crosslinked epoxy resin 106 are mechanically connected through entanglement and chemically connected through crosslinking 108. In some other embodiments, the crosslinking 108 is omitted such that a true interpenetrating polymer network forms where the crosslinked epoxy resin 104 and the crosslinked polysiloxane resin 106 are entangled and penetrate with one another but are substantially not or more preferably not crosslinked with one another. In other words, in such a true interpenetrating polymer network, the crosslinked epoxy resin 106 is mechanically connected through entanglement but not chemically connected with the crosslinked polysiloxane resin 108.

FIG. 2 presents a magnified view of some embodiments of the polysiloxane resin regions 106 coupled to the substrate 102. In some embodiments, the substrate 102 comprises a metal, such as a cold roll steel, aluminum, or some other suitable metal. In some other embodiments, the substrate 102 comprises a plastic, a composite comprising plastic and metal, a glass, a ceramic, or some other material. At least when the substrate 102 comprises cold rolled steel, the silicon based compound comprising hydroxyl and/or amino functional groups may hydrolyze first and then condense with hydroxyl groups on the substrate 102 to form covalent bonds with the surface of the substrate 102. The silicon based compounds may also bond to each other via condensation reactions. A grafted polymer structure formed from the second silicon based compounds may form over the substrate 102. As shown in FIG. 2, additional functional groups (e.g., the NH₂ groups) may then be available for further reactions with the epoxy resin and other silicon based compounds. Thus, the silicon based compounds bonded to the substrate 102 assist in providing strong adhesion between the hybrid epoxy-polysiloxane etch primer and the substrate 102.

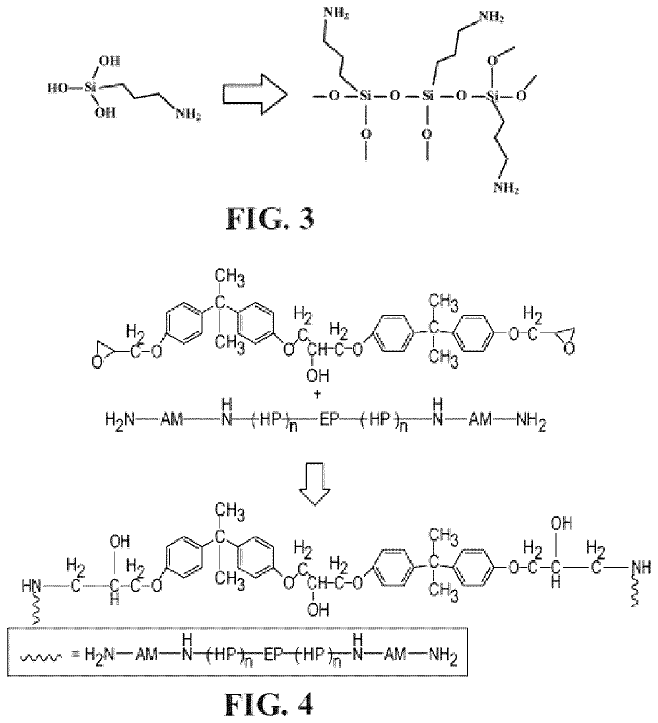

FIG. 3 presents a schematic of some embodiments of a condensation reaction, where a silicon based compound reacts with another silicon based compound to form a polysiloxane and byproduct water. In some embodiments, the first and/or second silicon based compound used to form the hybrid epoxy-polysiloxane etch primer each comprise at least one of an amino functional group or a hydroxyl functional group. For example, in FIG. 3, the silicon based compound is 3-aminopropyltriethoxysilane.

FIG. 4 presents a schematic of some embodiments of the reaction between an epoxy resin and an aliphatic amine compound to form crosslinked epoxy resin. As seen in FIG. 4, in some embodiments, the aliphatic amine is a linear hybrid epoxy-amine compound that reacts with the epoxy resin via an opening-ring reaction. The unconventional abbreviations in the aliphatic hybrid epoxy-amine compound in FIG. 4 are defined as follows: “AM” means amine section; “EP” means epoxy resin section; and “HP” means hydrophilic section. In some other embodiments, the aliphatic amine used to react with the epoxy resin regions does not comprise epoxy resin sections. In some embodiments, a silicon based compound also facilitates this reaction. The silicon based compound comprises at least one of a hydroxyl functional group or an amino functional group. Thus, in some embodiments, the crosslinked epoxy resin regions in the hybrid epoxy-polysiloxane etch primer are formed at least from an epoxy resin, an aliphatic amine, and a first silicon based compound.

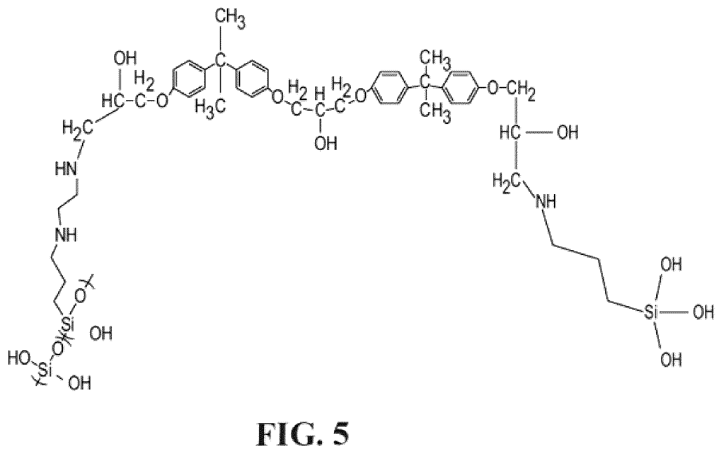

FIG. 5 presents a schematic of some embodiments of a product formed by an epoxy resin and a silicon based compound. In some such embodiments, amino groups from a silicon based compound will also react with the epoxy resin to bind with the crosslinked epoxy resin. Further, when applied to a substrate having free hydroxyl groups, any hydroxyl groups from the silicon based compound can condense with hydroxyl groups on a surface of the substrate, which improves the adhesive strength of the hybrid epoxy-polysiloxane etch primer with the substrate.

A combination of the reactions illustrated in FIGS. 2-5 occur upon mixing the epoxy resin, the first silicon based compound, the second silicon based compound, and the aliphatic amine and applying the mixture to a substrate to form the disclosed hybrid epoxy-polysiloxane etch primer. The structures and amounts of the first and second silicon based compounds, which may be the same or different from one another, influence the resulting structure and properties of the hybrid epoxy-polysiloxane etch primer.

For example, in some embodiments, the first and/or second silicon based compounds comprise polysiloxanes containing one or more amino or hydroxyl functional groups or organosilanes containing one or more amino or hydroxyl functional groups. Suitable organosilanes include, for example, organosilanes having weight average molecular weights of 100 to 3000, organosilanes having cage structures (e.g., silsesquioxanes), and the like. An example of a silsesquioxane having amino functional groups includes aminoethylaminopropyl-methylsilsesquioxane. Further, in some embodiments, the first and/or second silicon based compounds containing one or more amino or hydroxyl functional groups has the formula of R¹O—[O—Si—(OH)(—R²—NH₂)]ₓ—OR³, where R¹ is independently H, an alkyl group, an aryl group, or a group of formula (R⁴O)2Si—; each R² is independently an alkylene or arylene group; R³ is independently H, an alkyl group, an aryl group, or a group of formula —Si(—OR⁴)₂(—R²—NH₂); each R⁴ is independently H, an alkyl group or an aryl group; and x is an integer from 1 to 5000. In some embodiments, R¹ is preferably H and each R² is preferably, a C₁-C₆ alkylene group or more preferably, a C₃ alkylene group. In some other embodiments, the silicon based compound may comprise or be formed from a nanoparticles embedded in a silane oligomer. With a variety of options for the first and/or second silicon based compounds, the properties of the hybrid epoxy-polysiloxane etch primer can be tuned for a particular application.

Similarly, one or more types of epoxy resins may be used to achieve desired properties of the hybrid epoxy-polysiloxane etch primer. For example, the epoxy resin includes, but is not limited to, epoxies formed from epichlorohydrin and one or more bisphenol compounds. The one or more bisphenol compounds can be any suitable bisphenol compound and can be selected based on the end properties desired from the crosslinked epoxy resin regions of the hybrid etch primer. In certain embodiments, the bisphenol compound includes but is not limited to one or more compounds selected from the following:

| Structural formula | Name | CAS |
|---|---|---|
| 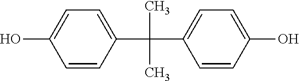 [SMILES: CC(C)(c1ccc(O)cc1)c1ccc(O)cc1] | Bisphenol A | 80-05-7 |
| 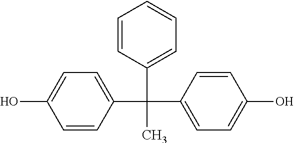 [SMILES: CC(c1ccccc1)(c1ccc(O)cc1)c1ccc(O)cc1] | Bisphenol AP | 1571-75-1 |
| 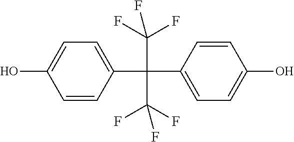 [SMILES: Oc1ccc(C(c2ccc(O)cc2)(C(F)(F)F)C(F)(F)F)cc1] | Bisphenol AF | 1478-61-1 |
| 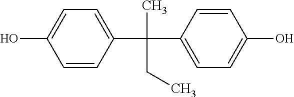 [SMILES: CCC(C)(c1ccc(O)cc1)c1ccc(O)cc1] | Bisphenol B | 77-40-7 |
| 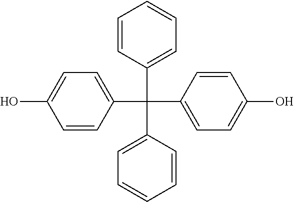 [SMILES: Oc1ccc(C(c2ccccc2)(c2ccccc2)c2ccc(O)cc2)cc1] | Bisphenol BP | 1844-01-5 |
| 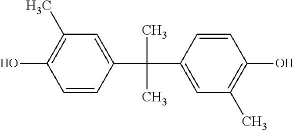 [SMILES: Cc1cc(C(C)(C)c2ccc(O)c(C)c2)ccc1O] | Bisphenol C | 79-97-0 |
| 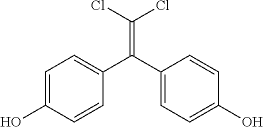 [SMILES: Oc1ccc(C(=C(Cl)Cl)c2ccc(O)cc2)cc1] | Bisphenol C 2 | 14868-03-2 |
| 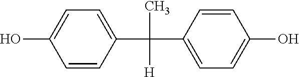 [SMILES: CC(c1ccc(O)cc1)c1ccc(O)cc1] | Bisphenol E | 2081-08-5 |
| 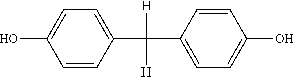 [SMILES: Oc1ccc(Cc2ccc(O)cc2)cc1] | Bisphenol F | 620-92-8 |
| 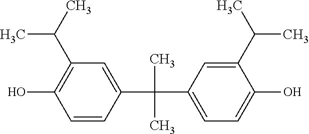 [SMILES: CC(C)c1cc(C(C)(C)c2ccc(O)c(C(C)C)c2)ccc1O] | Bisphenol G | 127-54-8 |
| 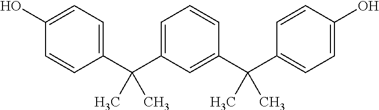 [SMILES: CC(C)(c1ccc(O)cc1)c1cccc(C(C)(C)c2ccc(O)cc2)c1] | Bisphenol M | 1395-25-0 |
| 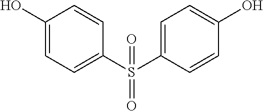 [SMILES: O=S(=O)(c1ccc(O)cc1)c1ccc(O)cc1] | Bisphenol S | 80-09-1 |
| 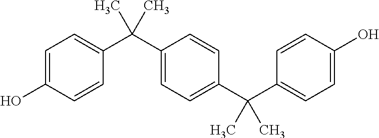 [SMILES: CC(C)(c1ccc(O)cc1)c1ccc(C(C)(C)c2ccc(O)cc2)cc1] | Bisphenol P | 2167-51-3 |
| 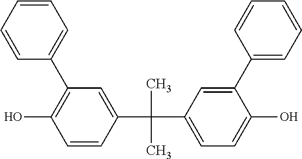 [SMILES: CC(C)(c1ccc(O)c(-c2ccccc2)c1)c1ccc(O)c(-c2ccccc2)c1] | Bisphenol PH | 24038-68-4 |
| 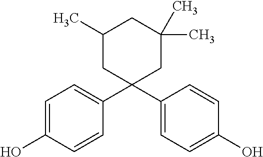 [SMILES: CC1CC(C)(C)CC(c2ccc(O)cc2)(c2ccc(O)cc2)C1] | Bisphenol TMC | 129188-99-4 |
| 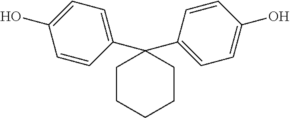 [SMILES: Oc1ccc(C2(c3ccc(O)cc3)CCCCC2)cc1] | Bisphenol Z | 843-55-0 |
| 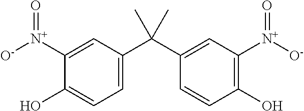 [SMILES: CC(C)(c1ccc(O)c([N+](=O)[O-])c1)c1ccc(O)c([N+](=O)[O-])c1] | Dinitrobisphenol A | 5329-21-5 |
| 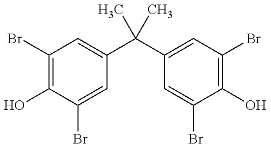 [SMILES: CC(C)(c1cc(Br)c(O)c(Br)c1)c1cc(Br)c(O)c(Br)c1] | Tetrabromobisphenol A | 79-94-7 |

Preferably the one or more bisphenol compounds are selected from the group consisting of bisphenol A, bisphenol B, bisphenol E, bisphenol F, and bisphenol AF.

Curing (or crosslinking) of the epoxy resin is at least based on an opening-ring reaction when the epoxy resin is mixed with aliphatic amines as discussed above with respect to FIG. 4. Additionally, under certain conditions, the epoxy resin may also cure with itself (homopolymerisation) or by forming a copolymer with polyfunctional curatives or hardeners. This curing is what produces the qualities of the substance such as resistance, durability, versatility, and adhesion. Any desired molecule containing a reactive hydrogen, such as the first silicon based compound comprising hydroxyl functional groups, may be used to react with the epoxide groups of the epoxy resin. Common classes of hardeners for epoxy resins include amines, acids, acid anhydrides, phenols, alcohols and thiols. These have a relative reactivity (lowest first) approximately in the order: phenol<anhydride<aromatic amine<cycloaliphatic amine<aliphatic amine<thiol. While some epoxy resin/hardener combinations will cure at ambient temperature, some may require heat. Temperature is sometimes increased in a step-wise fashion to control the rate of curing and prevent excessive heat build-up from the exothermic reaction.

Hardeners which show only low or limited reactivity at ambient temperature, but which react with epoxy resins at elevated temperature are referred to as latent hardeners. When using latent hardeners, the epoxy resin and hardener may be mixed and stored for some time prior to use, which is advantageous for many industrial processes. For example, when the hybrid epoxy-polysiloxane etch primer is sold to customers as a 2K system, the epoxy resin and hardeners may be sold as a first part, and the aliphatic amine and silicon based compounds may be sold as the second part. Upon mixing the first and second parts and heating the mixture, the epoxy resin may crosslink to form crosslinked epoxy resin regions via reaction with the latent hardeners, any hydroxyl and/or amino functional groups from the silicon based compounds, the aliphatic amine, and even possibly via homopolymerisation.

The epoxy curing reaction may also be accelerated by addition of small quantities of accelerators. Tertiary amines, carboxylic acids and alcohols (especially phenols) are effective accelerators. The accelerators and/or hardeners may be present in the first part or the second part of the 2K system given the first part or the second part remain shelf-stable with these additives. In some other embodiments, additional accelerators, hardeners, and other additives may be omitted from the 2K system.

The hybrid epoxy-polysiloxane etch primer of the present invention may also include other optional ingredients that do not adversely affect the hybrid etch primer composition or a cured coating resulting therefrom. Such optional ingredients include, for example, catalysts, dyes, pigments, toners, extenders, fillers, lubricants, anticorrosion agents, flow control agents, thixotropic agents, dispersing agents, antioxidants, adhesion promoters, light stabilizers, surfactants, and mixtures thereof. Each optional ingredient is preferably included in a sufficient amount to serve its intended purpose, but not in such an amount to adversely affect the hybrid etch primer or a cured coating resulting therefrom. For example, when the disclosed hybrid epoxy-polysiloxane etch primer is formulated as a 2K system, these optional ingredients preferably do not promote crosslinking within the epoxy resin in the first part such that the first part remains shelf-stable and is available for crosslinking upon mixing with the second part. Similarly, these optional ingredients preferably do not promote reactions within the second part which includes the aliphatic amine and the silicon based compounds such that the second part also remains shelf-stable and enough of the aliphatic amine and silicon based compounds remain available for reactions when mixed with the first part comprising the epoxy resin.

In some embodiments, the epoxy-polysiloxane waterborne hybrid etch primer can be prepared by any desired method by which the epoxy resin, aliphatic amine, and silicon based compound(s) containing one or more amino or hydroxyl functional groups react and become a crosslinked network having crosslinked epoxy resin regions and crosslinked polysiloxane resin regions.

When the hybrid epoxy-polysiloxane etch primer is a 2K system, the first part comprises the epoxy resin and the second part comprises the aliphatic amine and the silicon based compound(s). As a non-limiting example, in some embodiments, the epoxy resin comprises a latex epoxy dissolved in de-ionized water as a primary solvent and an organic solvent as a co-solvent. Because water is the primary solvent, meaning because there is more water than organic solvent, the overall epoxy resin is still considered waterborne. In one exemplary embodiment, the co-solvent may be dipropylene glycol dimethyl ether. In some embodiments, the epoxy resin further comprises various dispersants, deformers, pigments, anti-rust agents, anti-corrosion agents, fillers, leveling agents, epoxy latex, rheology modifiers, binders, and the like. As a non-limiting example, in some embodiments, the second part comprises an aliphatic amine, a first silicon based compound such as a silane oligomer with hydroxyl and amine groups, and a second silicone based compound such as a silane with amine and hydroxyl groups, wherein these aforementioned components are dissolved within a solution. Like the epoxy resin of the first part, the solution of the second part may also comprise de-ionized water as a primary solvent and an organic solvent. The second part is also waterborne such that when the first part and the second part are mixed together, the hybrid etch primer composition remains waterborne.

Other non-limiting examples of suitable organic solvents for use in the primarily waterborne coating compositions of the present invention include aliphatic hydrocarbons (e.g., mineral spirits, kerosene, VM&P NAPHTHA solvent, and the like); aromatic hydrocarbons (e.g., benzene, toluene, xylene, the SOLVENT NAPHTHA 100, 150, 200 products and the like); alcohols (e.g., ethanol, n-propanol, isopropanol, n-butanol, iso-butanol and the like); ketones (e.g., acetone, 2-butanone, cyclohexanone, methyl aryl ketones, ethyl aryl ketones, methyl isoamyl ketones, and the like); esters (e.g., ethyl acetate, butyl acetate and the like); glycols (e.g., butyl glycol); glycol ethers (e.g., ethylene glycol monomethyl ether, ethylene glycol monoethyl ether, ethylene glycol monobutyl ether, propylene glycol monomethyl ether, and the like); glycol ether esters (e.g., butyl glycol acetate, methoxypropyl acetate and the like); and mixtures thereof.

When stored, each part of the 2K system is individually substantially unreactive, meaning the first part and the second part are individually shelf-stable. For example, the first part, comprising the epoxy resin, remained shelf-stable or substantially unreactive when maintained at 40 degrees Celsius for 30 days. For example, some formulations of the waterborne epoxy resin used in the 2K system showed a minor variation (about 10 Krebs units) in viscosity over the 30 days. Similarly, some formulations of the waterborne epoxy resin used in the 2K system showed a minor variation (about 1 pH unit) in pH over the 30 days. In some embodiments, the viscosity of the first part is in a range of between about 40 Krebs units and about 80 Krebs units, and the pH of the first part is in a range of between about 7 and about 10, for example. Similar results were obtained, further illustrating the shelf-stability of the waterborne epoxy resin used herein, when the first part comprising the epoxy resin was stored at 50 degrees Celsius for 8 weeks.

When shelf-stability is desired, the epoxy resin may be formulated such that homopolymerisation of the epoxy resin is unlikely at the anticipated temperature conditions for storage such that the epoxide rings remain closed and available for a ring-opening reaction when the epoxy resin is later mixed with the second part. The second part, comprising a mixture of the aliphatic amine and silicon based compound(s) showed almost no change in viscosity when stored at 40 degrees Celsius for 36 days. In some embodiments, increasing the concentration of amines and silanes in the second part does increase the viscosity of the second part, but even with a higher concentration of amines and silanes, the second part still remains substantially unreactive when stored at 40 degrees Celsius for 36 days. In some embodiments, the viscosity of the second part is in a range of between about 40 Krebs units and about 60 Krebs units, for example. If the viscosity of the first or second part is too high, then water can be added to the respective part to reduce the viscosity.

It will be appreciated that the epoxy resin in the first part may comprise other functional groups within its polymer chains given these other functional groups are substantially unreactive with the epoxy resin and other components of the first part such that the first part remains shelf-stable. Similarly, it will be appreciated that the silicon based compound comprising at least one amino or hydroxyl functional group may contain other functional groups within its polymer chains given these other functional groups are substantially unreactive with the amino and/or hydroxyl groups of the silicon based compound and also substantially unreactive with the aliphatic amine such that the second part remains shelf-stable. Additionally, it will be appreciated that the aliphatic amine may contain other functional groups within its polymer chains given these other functional groups are substantially unreactive with the amino and/or hydroxyl groups of the silicon based compound and also substantially unreactive with the aliphatic amine such that the second part remains shelf-stable. Any additional functional groups in the first and/or second part should also be selected such that when the first and second parts are combined, the crosslinking reactions to form the hybrid epoxy-polysiloxane etch primer can still occur.

When a substrate is ready for coating, the first part is mixed with the second part at a predetermined ratio to begin forming a network comprising crosslinked epoxy resin regions and crosslinked polysiloxane resin regions. For example, in some embodiments, a ratio between the equivalent weight of epoxide groups in the first part to the amine groups in the second part may be in a range of between preferably about 1:5 and about 2:1, more preferably about 2:5 and about 1.5:1, or even more preferably about 4:5 to about 1.4:1. In some embodiments, the first part comprising the weight of the epoxy resin is preferably about 50 percent to about 80 percent, more preferably about 60 percent to about 75 percent, and even more preferably about 65 percent to about 70 percent of the total weight of the mixture of the first and second parts. In some embodiments, the weight of the first and second silicon based compounds together make up about preferably 5 percent to about 10 percent or more preferably about 7 to about 9 percent of the total weight of the mixture of the first and second parts. It will be appreciated that the ratio of functional groups and components within the 2K system upon mixing may be tuned for desirable properties such as potlife, mechanical strength, adhesion, corrosion resistance, and the like.

The first part and the second part may be mixed together using a paint stick, a bucket agitator, an electric mixing attachment, or some other suitable tool at room temperature. The speed of reaction for crosslinking the epoxy resin upon mixing the first part and the second part may be measured, for example, by FTIR by monitoring a change in the epoxy resin reactant. Such a “change” may be a change in structure or amount of a reactant, functional group, byproduct, or a change in some other indicator that the reaction has progressed. For example, in some embodiments, the disappearance of the epoxy ring, which indicates the progression of crosslinking the epoxy resin, corresponds to change in peaks on the FTIR associated with asymmetric C—O—C stretching vibrations. The reaction rate of the crosslinked epoxy resin is initially fast due to collision of the epoxy ring and amino functional groups upon mixing the first part and the second part. The reaction rate of the crosslinked epoxy resin generally slows as the epoxy rings open, the available amino functional groups are consumed, and/or the viscosity of the mixture increases thereby slowing collisions between the epoxy rings and the amino functional groups. In some embodiments, the reaction rate of the epoxy resin crosslinking decreases as a ratio of equivalent weight of epoxy to amine increases. For example, in some embodiments, when the ratio of equivalent weight of epoxy to amine is between about 0.75 and about 0.85, about 25% of the epoxide groups react after 600 minutes, whereas when the ratio of equivalent weight of epoxy to amine is between about 1.00 and 1.10, about 25% of the epoxide groups react after about 1200 minutes.

While the hybrid epoxy-polysiloxane etch primer can be sold as a 2K system, it will be appreciated that in some industrial settings, more than two components may be used; for example, the aliphatic amine, first silicon based compound, second silicon based compound, and/or any other additives may be sequentially or simultaneously added to the waterborne epoxy primer. If the components of the second part are added sequentially, the time between adding each component should be minimized to allow the various crosslinking reactions within the mixture to occur simultaneously to form the crosslinked network.

In some embodiments, the potlife of the mixture of the first and second parts may be in a range of between about 1 hour and about 5 hours. The resulting mixture of the hybrid epoxy-polysiloxane etch primer composition may be applied to a prepared substrate as a coating via rolling, brushing, spraying, or some other suitable coating method. The coating may be applied at a thickness of between, for example, approximately 1 mils and approximately 5 mils. In some embodiments, before coating, the substrate is prepared via sanding, cleaning with solvent, and/or some other suitable surface preparation method to remove contaminants and promote adhesion with the hybrid epoxy-polysiloxane etch primer. Thus, the hybrid epoxy-polysiloxane etch primer may be applied directly to the prepared substrate or may be applied to some pretreatment layer on the substrate such as another etch primer layer. As discussed with respect to FIG. 2, once the hybrid epoxy-polysiloxane etch primer is applied to the substrate, covalent bonds may be formed between a surface of the substrate and the one or more silicon based compounds. Several crosslinking reactions between the epoxy resin, the one or more silicon based compounds, and the aliphatic amine progress to form the network of crosslinked epoxy resin regions and crosslinked polysiloxane regions. For example, crosslinking between the crosslinked epoxy resin regions and the crosslinked polysiloxane resin regions can be also generated by oligomers of epoxy resin and silanes with functional double bonds from the first and/or second silicon based compounds by redox reactions, UV or gamma-irradiation, atom transfer radical polymerization (ATRP), and/or reversible addition fragmentation chain transfer (RAFT). ATRP reactions can be performed using procedures known in the art, such as those described in Matyjaszewski, K., “Advanced Materials by Atom Transfer Radical Polymerization”, Adv. Mater. 2018, 30, 1706441, the contents of which are incorporated herein by reference. RAFT polymerization can be performed using procedures known in the art, such as those described in Semsarilar, M. et al., “Polymerizations by RAFT: Developments of the Technique and Its Application in the Synthesis of Tailored (Co)polymers”, Macromol. Chem. Phys. 2020, 2000311, the contents of which are incorporated herein by reference. Because of the many reactions, the hybrid epoxy-polysiloxane etch primer has a high cross-linking density, which improves its anticorrosion properties.

One or more hybrid epoxy-polysiloxane etch primer layers may be applied to the substrate. In some embodiments, the hybrid epoxy-polysiloxane etch primer layer is configured to receive a waterborne primer layer. In some other embodiments, the hybrid epoxy-polysiloxane etch primer layer may function as both an etch primer layer and as a primer layer such that an additional primer layer may be omitted; in some such other embodiments, a base coat may be applied directly to the hybrid epoxy-polysiloxane etch primer layer. In some embodiments a primer layer is applied over the hybrid epoxy-polysiloxane etch primer layer, adhesion between the hybrid epoxy-polysiloxane etch primer layer and the primer layer is improved when the primer layer is also waterborne. In some other embodiments, the hybrid epoxy-polysiloxane etch primer layer may receive some overlying solvent borne coating.

In some embodiments, the waterborne primer layer applied to the hybrid epoxy-polysiloxane etch primer layer may be, for example, a waterborne polyurethane coating, a waterborne hybrid epoxy-polyurethane coating, or some other suitable primer coating. The hybrid epoxy-polysiloxane etch primer layer may be especially suitable for adhering to polyurethane-containing coatings because of the increased amine functionality in the hybrid epoxy-polysiloxane etch primer. Any unreacted, available amine groups from the aliphatic amine and the first and/or second silicon based compounds may react with isocyanates from the polyurethane-containing primer layer, thereby forming a strong adhesion between the hybrid epoxy-polysiloxane etch primer layer and the overlying polyurethane-containing primer coating. Additionally, in some embodiments, polyurethane-containing primers have a faster drying time than the hybrid epoxy-polysiloxane etch primer layer. In some such embodiments, the polyurethane-containing primer can be applied to the hybrid epoxy-polysiloxane etch primer layer when the hybrid epoxy-polysiloxane etch primer layer is tack-free, even if the hybrid epoxy-polysiloxane etch primer layer is not yet dried. In some embodiments, the hybrid epoxy-polysiloxane etch primer may dry as tack-free via forced air at room temperature within 10 minutes. The hybrid epoxy-polysiloxane etch primer layer coated by a polyurethane-containing primer layer may together have a fast enough drying time comparable to conventional etch primer layer-primer layer coatings systems.

In some embodiments, a base coat and a clear coat are further applied to the primer layer to form a coatings system over the substrate. Thus, the coatings system may comprise the hybrid epoxy-polysiloxane etch primer layer; a polyurethane-containing primer layer over the hybrid epoxy-polysiloxane etch primer layer; a base coat over the polyurethane-containing primer layer; and a clear coat over the base coat. It will be appreciated that the coatings system may comprise one or more of each of the aforementioned coating layers. This coatings system may adhere to and protect the substrate. In some embodiments, one or more of the layers in the coatings system may be sanded prior to applying a subsequent layer of the coating system to promote a smooth finish. In some embodiments, because of the slower dry time of the hybrid epoxy-polysiloxane etch primer, sanding of the hybrid epoxy-polysiloxane etch primer may be omitted.

As a non-limiting example, in some embodiments, the polyurethane-containing primer layer is waterborne polyurethane primer. The polyurethane-containing primer may comprise a polyurethane resin component and a crosslinking component that when mixed together, forms a network comprising crosslinked polyurethane. Thus, the waterborne polyurethane may also be a 2K system. In some embodiments, the waterborne polyurethane comprises de-ionized water as a primary solvent and an organic solvent as a co-solvent. Because water is the primary solvent, meaning because there is more water than organic solvent, the overall polyurethane is still considered waterborne. In one exemplary embodiment, the co-solvent may be dipropylene glycol dimethyl ether. In some embodiments, the polyurethane-containing primer layer further comprises various dispersants, deformers, pigments, anti-rust agents, anti-corrosion agents, fillers, leveling agents, epoxy latex, rheology modifiers, binders, and the like.

As another non-limiting example, in some embodiments, the polyurethane-containing primer layer is waterborne hybrid epoxy-polyurethane primer. The waterborne hybrid epoxy-polyurethane primer may have a fast drying time such that it can be sanded after one hour of drying at room temperature. In some embodiments, the hybrid epoxy-polyurethane waterborne primer is obtained by blending an epoxy resin and a polyurethane waterborne dispersion (or aqueous dispersion) together with an isocyanate compound. The reactions between the polyurethane dispersion and isocyanate, and the epoxy resin and isocyanate generate two crosslinked networks. These two crosslinked networks can be crosslinked with one another by the isocyanate as curing agent, by which the adhesive and mechanical strength of film can be dramatically improved. The polyurethane dispersion is preferably formed from one of an aliphatic diisocyanate or aromatic diisocyanate, one or more diols or polyols, a catalyst, and optionally, one or more additives selected from the group consisting of chain extenders and crosslinkers conventional in polyurethane chemistry. In certain embodiments, the polyurethane dispersion comprises one or more hydroxyl and/or carboxyl functional groups reactive with one or both of the isocyanate containing compound and the epoxy resin, in order to permit formation of the crosslinked network of the hybrid primer of these embodiments.

The following examples of improved properties of the hybrid epoxy-polysiloxane etch primer are provided to illustrate the present invention and its advantages but should not be construed as limiting a scope of the invention.

The following data was collected by comparing a conventional solvent borne coatings system with a waterborne first coatings system and a waterborne second coatings system. Each of the coatings systems comprises an etch primer layer over a substrate; a primer layer over the etch primer layer; a basecoat over the primer layer; and a clearcoat over the basecoat. The composition of the etch primer layer and/or the primer layer vary amongst coatings systems as presented in TABLE 1.

TABLE 1

| Generic | CONVENTIONAL | FIRST | SECOND |
|---|---|---|---|
| Layer | COATINGS | COATINGS | COATINGS |
| Type | SYSTEM | SYSTEM | SYSTEM |
| CLEARCOAT | Conventional | Conventional | Conventional |
| | Clearcoat | Clearcoat | Clearcoat |
| BASECOAT | Conventional | Conventional | Conventional |
| | Black Basecoat | Black Basecoat | Black Basecoat |
| PRIMER | Solvent borne | Waterborne | Waterborne |
| | Polyurethane | Polyurethane | Hybrid Epoxy- |
| | | Primer | Polyurethane |
| | | | Primer |
| ETCH | Solvent borne Etch | Waterborne | Waterborne |
| PRIMER | Primer | Hybrid Epoxy- | Hybrid Epoxy- |
| | | Polysiloxane | Polysiloxane |
| | | Etch Primer | Etch Primer |
| SUBSTRATE | Cold Rolled | Cold Rolled | Cold Rolled |
| | Steel | Steel | Steel |

Thus, as shown in TABLE 1, the conventional coatings system comprises a conventional solvent borne etch primer layer over a cold roll steel substrate; a conventional solvent borne polyurethane over the conventional solvent borne etch primer layer; a conventional black basecoat layer over the conventional solvent borne polyurethane primer layer; and a conventional clearcoat layer over the conventional black basecoat layer. As shown in TABLE 1, the first coatings system comprises the hybrid epoxy-polysiloxane etch primer layer over a cold roll steel substrate; a waterborne polyurethane primer layer over the hybrid epoxy-polysiloxane etch primer layer; a conventional black basecoat layer over the waterborne polyurethane primer layer; and a conventional clearcoat layer over the conventional black basecoat layer. As shown in TABLE 1, the second coatings system comprises the hybrid epoxy-polysiloxane etch primer layer over a cold roll steel substrate; a waterborne hybrid epoxy-polyurethane primer layer over the hybrid epoxy-polysiloxane etch primer layer; a conventional black basecoat layer over the waterborne hybrid epoxy-polyurethane primer layer; and a conventional clearcoat layer over the conventional black basecoat layer.

For each of the conventional, first, and second coatings system, the cold roll steel substrates were prepared by sanding and cleaning the substrate with a solvent; drying the steel substrate at room temperature; spraying the appropriate etch primer layer to the prepared substrate; drying the appropriate etch primer layer at room temperature for one hour; applying the appropriate primer layer to the appropriate etch primer layer; drying the appropriate primer layer; sanding the appropriate primer layer; applying a black basecoat layer to the appropriate primer layer; drying the black basecoat layer for one hour; and applying a clearcoat layer to the black basecoat layer.

In some embodiments of the first and second coatings system, the dry film thickness of the waterborne hybrid epoxy-polysiloxane etch primer layer is in a range of about, for example, 0.5 mil and about 2.5 mil. The chemical and mechanical properties of the first coatings system did not vary significantly based on dry film thickness of the waterborne hybrid epoxy-polysiloxane etch primer layer. In some embodiments, the dry film thickness of the waterborne polyurethane-containing primer layer is in a range of about, for example, 3 mil and about 5 mil. In some embodiments, the dry film thickness of the black basecoat layer is in a range of about, for example, 0.3 mil and about 1.2 mil. In some embodiments, the dry film thickness of the clearcoat layer is in a range of about, for example, 2 mil and about 6 mil. It will be appreciated that other dry film thickness values may be used as long as ample drying time is allowed between coating of layers. Additionally, for the following data collection, corresponding layers in the conventional, first, and second coatings systems had the same or similar dry film thicknesses to remove thickness as a variable from these test results.

In some embodiments, the chemical resistance of just the etch primer layer and the primer layer arranged on the substrate of each coatings system can be tested by rubbing a paper soaked in methyl ethyl ketone (MEK) solvent on the substrate according to ASTM D5402-19. If the substrate is not exposed after 300 cycles of rubbing with MEK solvent, then the hybrid epoxy-polysiloxane etch primer coating is considered to be “chemically resistance.” The etch primer layer and the primer layer of conventional coatings system and the first coatings system can both withstand at least 300 cycles and thus, are both sufficiently “chemically resistant.” In the etch primer layer and the primer layer of second coatings system, the substrate was exposed after 295 cycles of rubbing with MEK solvent when a thicker layer of the hybrid epoxy-polysiloxane etch primer was used but surpassed the 300 cycles of rubbing when a thinner layer of the hybrid-polysiloxane etch primer was used. Thus, the chemical resistance of the etch primer and primer layers second coatings system is comparable to the chemical resistance results of the etch primer and primer layers of both the conventional and first coatings systems.

In some embodiments, the adhesive strength of each coatings system can be evaluated using crosshatch testing according to ASTM D3359. This test evaluates adhesive strength by applying and removing pressure-sensitive tape over cuts made in the coating. The substrate and coatings are monitored to see if the coatings peel away from the substrate and/or stick to the tape. Upon performing this adhesive strength test to just the etch primer and primer layer of each coatings system and also to the entirety of each coatings system, each coatings system had the comparable adhesive strength values.

In some embodiments, the impact resistance of each coatings system can be evaluated according to ASTM D5420. This test evaluates direct and non-direct impact strength of the coatings. Upon performing this impact resistance test, the conventional coatings system, the first coatings system, and the second coatings system had substantially the same results. Stone chip testing was also performed to evaluate coating durability, and the results were similar between the conventional, first, and second coatings systems.

In some embodiments, the film flexibility of each coatings system can be evaluated according to a conical mandrel bend test disclosed in ASTM D522. Upon performing this flexibility test, each of the coatings systems received a passing score, meaning each coatings system exhibited a sufficient film flexibility for its intended applications.

In some embodiments, the optical appearance of each coatings system can be evaluated according to gloss retention at 20 degrees and/or distinctness of image (DOI) retention. Upon performing these optical appearance tests, each coatings system had similar gloss and DOI scores. Each of the coatings systems had gloss values between 85 and 90. Most of the coatings systems had DOI scores between about 85 and 97. The conventional coatings system having a thinner layer of etch primer had a lower DOI score of about 75.

In some embodiments, the dry time to a tack-free coating and the pot life was measured for each coatings system. Upon performing dry time and pot life tests, each coatings system had a comparable tack-free dry time (e.g., less than 15 minutes or more preferably less than 10 minutes with air force dry) and pot life (e.g., greater than 60 minutes).

To test the coating's behavior in a corrosive environment, each coatings system (without the basecoat and the clearcoat layers) may be placed in a salt fog chamber at an elevated temperature for a few weeks (e.g., about 30 degrees Celsius for about 20 days). Prior to loading the substrates into the salt fog chamber, a scratch may be intentionally made into the primer layer and the etch primer layer of each coatings system. In some embodiments, the salt fog chamber testing is conducted in accordance with ASTM B117. After removing the substrates from the salt fog chamber, the amount of delamination and corrosion that occurred at the scratch is evaluated upon cleaning the substrates with hot water and removing any film loss. In majority of the samples, the first and second coatings systems had significantly less delamination and corrosion when compared to the conventional samples. The first coatings system with a thicker layer of the hybrid epoxy-polysiloxane (e.g., about 2 mils) had slightly less favorable results when compared to the conventional coatings system. The first coatings system with a thinner layer of the hybrid epoxy-polysiloxane (e.g., about 1.0 mils) had significantly more favorable delamination results and slightly more favorable corrosion results when compared to the conventional coatings system. It was also observed in the second coatings system that there is a better anticorrosion performance in the second coatings system when there is a higher equivalent ratio of —NCO to —OH in the hybrid epoxy-polyurethane prime layer over the hybrid epoxy-polysiloxane etch primer layer.

The optical appearance and adhesive loss of each sample was tested after being placed in a humidity chamber for 4 days. The optical appearance values were quantified by testing gloss retention at 20 degrees and DOI. Each sample was tested before entering the humidity chamber; within one hour after exiting the humidity chamber; and within 24 hours after exiting the humidity chamber. Majority of the first and second coatings systems had higher optical appearance values than the conventional coatings system, which can be attributed the improved chemical resistance provided by the first and second coatings systems compared to the conventional coatings systems. Because of the chemical resistance, the surface roughness of the first and second coatings systems minimally changed, and thus, the optical appearance values also minimally changed when compared to the surface roughness of the conventional coatings systems.

It was observed that the adhesive loss after the humidity chamber varied amongst the samples. For example, while majority of the samples from the first and second coatings systems had lower adhesive loss compared to the conventional coatings systems, after 24 hours, one sample of the first coatings system did have a higher adhesive loss than the conventional coatings system and the second coatings system. It was observed that failure in adhesive loss was commonly due to adhesion issues between the primer layer and the basecoat.

It can be appreciated that other test methods may be used to evaluate the above properties as well as other properties of each of the first and second coatings systems comprising the waterborne hybrid epoxy-polysiloxane etch primer and the conventional coatings system comprising conventional solvent borne coatings. Additionally, the above comparisons between the properties of each coatings system are exemplary and may change depending on the exact formulation and/or application method of each layer in each coatings system.

As evidenced by the above exemplary data, in total, the first coatings system (waterborne hybrid epoxy-polysiloxane etch primer with waterborne polyurethane primer) and the second coatings system (waterborne hybrid epoxy-polysiloxane etch primer with waterborne hybrid epoxy-polyurethane primer) had comparable or improved properties compared to the conventional solvent borne coatings system. Thus, the disclosed waterborne hybrid epoxy-polysiloxane etch primer coating has a lower amount of VOCs while providing similar or better properties than conventional solvent borne coatings systems.

The following are non-limiting examples of some embodiments of the present invention:

Embodiment 1. A primer system, comprising:
an etch primer comprising a network of crosslinked epoxy resin regions and crosslinked polysiloxane resin regions,
wherein the crosslinked epoxy resin regions comprise units from an epoxy resin, an aliphatic amine, and one or more first silicon based compounds containing one or more amino or hydroxyl functional groups,
wherein the crosslinked polysiloxane resin regions are formed from one or more second silicon based compounds containing one or more amino or hydroxyl functional groups,
wherein the first and second silicon based compounds containing one or more amino or hydroxyl functional groups may be the same or different from one another, and
wherein the crosslinked epoxy resin regions and crosslinked polysiloxane resin regions form the network optionally having the crosslinked epoxy resin regions and crosslinked polysiloxane resin regions crosslinked with one another.

Embodiment 2. The primer system of Embodiment 1, wherein the network comprises crosslinks between the crosslinked epoxy resin regions and the crosslinked polysiloxane resin regions.

Embodiment 3. The primer system of Embodiment 1, wherein the one or more first silicon based compounds containing one or more amino or hydroxyl functional groups are selected from the group consisting of polysiloxanes containing one or more amino or hydroxyl functional groups and organosilanes containing one or more amino or hydroxyl functional groups.

Embodiment 4. The primer system of any one of Embodiments 1 to 3, wherein the epoxy resin is formed of units from epichlorohydrin and one or more bisphenol compounds.

Embodiment 5. The primer system of Embodiment 4, wherein the one or more bisphenol compounds are selected from the group consisting of bisphenol A, bisphenol B, bisphenol E, bisphenol F, and bisphenol AF.

Embodiment 6. The primer system of Embodiment 3, wherein the one or more first silicon based compounds containing one or more amino or hydroxyl functional groups are organosilanes containing one or more amino or hydroxyl functional groups.

Embodiment 7. The primer system of Embodiment 6, wherein the organosilanes containing one or more amino or hydroxyl functional groups are selected from the group consisting of organosilanes having weight average molecular weights of 100 to 3000 and organosilanes having cage structures.

Embodiment 8. The primer system of Embodiment 7, wherein the organosilanes containing one or more amino or hydroxyl functional groups are organosilanes having cage structures selected from the group consisting of silsesquioxanes.

Embodiment 9. The primer system of any one of Embodiments 1 to 6, wherein the one or more first silicon based compounds containing one or more amino or hydroxyl functional groups has a formula R¹O—[O—Si—(OH)(—R²—NH₂)]ₓ—OR³, where R¹ is independently H, an alkyl group, an aryl group, or a group of formula (R⁴O)2Si—, each R² is independently an alkylene or arylene group, R³ is independently H, an alkyl group, an aryl group, or a group of formula —Si(—OR⁴)2(-R²—NH₂), each R⁴ is independently H, an alkyl group or an aryl group, and x is an integer from 1 to 5000.

Embodiment 10. The primer system of Embodiment 9, wherein R¹ is H and each R² is a C₁-C₆ alkylene group.

Embodiment 11. The primer system of one of Embodiment 9 or Embodiment 10, wherein each R² is a C₃ alkylene group.

Embodiment 12. The primer system of any one of Embodiments 1 to 11, wherein the one or more second silicon based compounds containing one or more amino or hydroxyl functional groups is selected from the group consisting of polysiloxanes containing one or more amino or hydroxyl functional groups and organosilanes containing one or more amino or hydroxyl functional groups.

Embodiment 13. The primer system of any one of Embodiments 1 to 12, wherein the one or more second silicon based compounds containing one or more amino or hydroxyl functional groups are organosilanes containing one or more amino or hydroxyl functional groups.

Embodiment 14. The primer system of Embodiment 13, wherein the organosilanes containing one or more amino or hydroxyl functional groups are selected from the group consisting of organosilanes having weight average molecular weights of 100 to 3000 and organosilanes having cage structures.

Embodiment 15. The primer system of Embodiment 14, wherein the organosilanes containing one or more amino or hydroxyl functional groups are organosilanes having cage structures selected from the group consisting of silsesquioxanes.

Embodiment 16. The primer system of any one of Embodiments 1 to 13, wherein the one or more second silicon based compounds containing one or more amino or hydroxyl functional groups has a formula R₁O—[O—Si—(OH)(—R²—NH₂)]ₓ—OR₃, where R¹ is independently H, an alkyl group, an aryl group, or a group of formula (R⁴O)2Si—, each R² is independently an alkylene or arylene group, R³ is independently H, an alkyl group, an aryl group, or a group of formula —Si(—OR⁴)₂(—R²—NH₂), each R⁴ is independently H, an alkyl group or an aryl group, and x is an integer from 1 to 5000.

Embodiment 17. The primer system of Embodiment 16, wherein R¹ is H and each R² is a C₁-C₆ alkylene group.

Embodiment 18. The primer system of one of Embodiment 16 or Embodiment 17, wherein each R² is a C₃ alkylene group.

Embodiment 19. The primer system of any one of Embodiments 1 to 18, wherein the one or more first silicon based compounds containing one or more amino or hydroxyl functional groups are the same as the one or more second silicon based compound containing one or more amino or hydroxyl functional groups.

Embodiment 20. The primer system of any one of Embodiments 1 to 18, wherein the one or more first silicon based compounds containing one or more amino or hydroxyl functional groups are different from the one or more second silicon based compounds containing one or more amino or hydroxyl functional groups.

Embodiment 21. A method of preparing the primer system of any one of Embodiments 1 to 20, comprising:
reacting the epoxy resin, aliphatic amine, the one or more first silicon based compounds containing one or more amino or hydroxyl functional groups, and the one or more second silicon based compounds containing one or more amino or hydroxyl functional groups in an aqueous medium to form the network of crosslinked epoxy resin regions and crosslinked polysiloxane resin regions.

Embodiment 22. The method of Embodiment 21, wherein the primer system is a two-part system comprising: a first part comprising the epoxy resin; and a second part comprising a mixture of the aliphatic amine, the first silicon based compound, and the second silicon based compound.

Embodiment 23. A method of preparing the primer system of any one of Embodiments 1 to 20, comprising:
bonding the one or more first silicon based compounds containing one or more amino or hydroxyl functional groups to hydroxyl or amino groups contained on a surface of a structure on which the primer system will be placed; reacting the epoxy resin with the aliphatic amine, residual one or more amino or hydroxyl functional groups of the thus bound one or more first silicon based compounds containing one or more amino or hydroxyl functional groups, and the one or more second silicon based compounds containing one or more amino or hydroxyl functional groups in an aqueous medium to form the network comprising crosslinked epoxy resin regions and crosslinked polysiloxane resin regions.

Embodiment 24. A primed substrate, comprising: a substrate having thereon an etch primer layer formed from the primer system of any one of Embodiments 1 to 20.

Embodiment 25. The primed substrate of Embodiment 24, further comprising a primer layer formed on the etch primer layer, wherein the primer layer is formed from a waterborne polyurethane primer or a waterborne hybrid epoxy-polyurethane primer.

Embodiment 26. The primed substrate of one of Embodiment 24 or Embodiment 25,
wherein the substrate is metal.

Embodiment 27. The primed substrate of any one of Embodiments 24 to 26, wherein the substrate is steel.

Embodiment 28. A method for priming a substrate, comprising: forming an etch primer layer on a surface of the substrate, wherein the etch primer layer is formed from the primer system according to any one of Embodiments 1 to 20.

Embodiment 29. The method of Embodiment 28, further comprising forming a primer layer on the etch primer layer, wherein the primer layer is formed from a waterborne polyurethane primer or a waterborne hybrid epoxy-polyurethane primer.

All methods described herein can be performed in any suitable order unless otherwise indicated herein or otherwise clearly contradicted by context. The use of any examples, or language describing an example (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

While the embodiments discussed herein have been related to the coatings and methods discussed above, these embodiments are intended to be examples only and are not intended to limit the applicability of these embodiments to only those discussions set forth herein.

The above description is merely illustrative of several possible embodiments of various aspects of the present invention, wherein equivalent alterations and/or modifications will occur to others skilled in the art upon reading and understanding this specification and the annexed drawings. In addition, although a particular feature of the invention may have been disclosed with respect to only one of several embodiments, such feature may be combined with one or more other features of the other embodiments as may be desired and advantageous for any given or particular application.

Additional modifications and variations of the present invention are possible in light of the above teachings. It is therefore to be understood that within the scope of the appended claims, the invention may be practiced otherwise than as specifically described herein.

What is claimed is:

1. A primer system, comprising:
an etch primer comprising a network of crosslinked epoxy resin regions and crosslinked polysiloxane resin regions,
wherein the crosslinked epoxy resin regions comprise units from an epoxy resin, an aliphatic amine, and one or more first silicon based compounds containing one or more amino or hydroxyl functional groups,
wherein the crosslinked polysiloxane resin regions are formed from one or more second silicon based compounds containing one or more amino or hydroxyl functional groups,
wherein the first and second silicon based compounds containing one or more amino or hydroxyl functional groups may be the same or different from one another, and
wherein the crosslinked epoxy resin regions and crosslinked polysiloxane resin regions form the network optionally having the crosslinked epoxy resin regions and crosslinked polysiloxane resin regions crosslinked with one another.

2. The primer system of claim 1, wherein the network comprises crosslinks between the crosslinked epoxy resin regions and the crosslinked polysiloxane resin regions.

3. The primer system of claim 1, wherein the one or more first silicon based compounds containing one or more amino or hydroxyl functional groups are selected from the group consisting of polysiloxanes containing one or more amino or hydroxyl functional groups and organosilanes containing one or more amino or hydroxyl functional groups.

4. The primer system of claim 1, wherein the epoxy resin is formed of units from epichlorohydrin and one or more bisphenol compounds.

5. The primer system of claim 4, wherein the one or more bisphenol compounds are selected from the group consisting of bisphenol A, bisphenol B, bisphenol E, bisphenol F, and bisphenol AF.

6. The primer system of claim 3, wherein the one or more first silicon based compounds containing one or more amino or hydroxyl functional groups are organosilanes containing one or more amino or hydroxyl functional groups.

7. The primer system of claim 6, wherein the organosilanes containing one or more amino or hydroxyl functional groups are selected from the group consisting of organosilanes having weight average molecular weights of 100 to 3000 and organosilanes having cage structures.

8. The primer system of claim 7, wherein the organosilanes containing one or more amino or hydroxyl functional groups are organosilanes having cage structures selected from the group consisting of silsesquioxanes.

9. The primer system of claim 1, wherein the one or more first silicon based compounds containing one or more amino or hydroxyl functional groups has a formula R¹O—[O—Si—(OH)(—R²—NH₂)]ₓ—OR³, where R¹ is independently H, an alkyl group, an aryl group, or a group of formula (R⁴O)2Si—, each R² is independently an alkylene or arylene group, R³ is independently H, an alkyl group, an aryl group, or a group of formula —Si(—OR⁴)2(-R²—NH₂), each R⁴ is independently H, an alkyl group or an aryl group, and x is an integer from 1 to 5000.

10. The primer system of claim 1, wherein the one or more second silicon based compounds containing one or more amino or hydroxyl functional groups is selected from the group consisting of polysiloxanes containing one or more amino or hydroxyl functional groups and organosilanes containing one or more amino or hydroxyl functional groups.

11. The primer system of claim 1, wherein the one or more second silicon based compounds containing one or more amino or hydroxyl functional groups are organosilanes containing one or more amino or hydroxyl functional groups.

12. The primer system of claim 11, wherein the organosilanes containing one or more amino or hydroxyl functional groups are selected from the group consisting of organosilanes having weight average molecular weights of 100 to 3000 and organosilanes having cage structures.

13. The primer system of claim 12, wherein the organosilanes containing one or more amino or hydroxyl functional groups are organosilanes having cage structures selected from the group consisting of silsesquioxanes.

14. The primer system of claim 1, wherein the one or more second silicon based compounds containing one or more amino or hydroxyl functional groups has a formula R₁O—[O—Si—(OH)(—R²—NH₂)]ₓ—OR₃, where R¹ is independently H, an alkyl group, an aryl group, or a group of formula (R⁴O)2Si—, each R² is independently an alkylene or arylene group, R³ is independently H, an alkyl group, an aryl group, or a group of formula —Si(—OR⁴)₂(—R²—NH₂), each R⁴ is independently H, an alkyl group or an aryl group, and x is an integer from 1 to 5000.

15. The primer system of claim 1, wherein the one or more first silicon based compounds containing one or more amino or hydroxyl functional groups are the same as the one or more second silicon based compound containing one or more amino or hydroxyl functional groups.

16. The primer system of claim 1, wherein the one or more first silicon based compounds containing one or more amino or hydroxyl functional groups are different from the one or more second silicon based compounds containing one or more amino or hydroxyl functional groups.

17. A method of preparing the primer system of claim 1, comprising:
reacting the epoxy resin, aliphatic amine, the one or more first silicon based compounds containing one or more amino or hydroxyl functional groups, and the one or more second silicon based compounds containing one or more amino or hydroxyl functional groups in an aqueous medium to form the network of crosslinked epoxy resin regions and crosslinked polysiloxane resin regions.

18. The method of claim 17, wherein the primer system is a two-part system comprising: a first part comprising the epoxy resin; and a second part comprising a mixture of the aliphatic amine, the first silicon based compound, and the second silicon based compound.

19. A method of preparing the primer system of claim 1, comprising:
bonding the one or more first silicon based compounds containing one or more amino or hydroxyl functional groups to hydroxyl or amino groups contained on a surface of a structure on which the primer system will be placed; reacting the epoxy resin with the aliphatic amine, residual one or more amino or hydroxyl functional groups of the thus bound one or more first silicon based compounds containing one or more amino or hydroxyl functional groups, and the one or more second silicon based compounds containing one or more amino or hydroxyl functional groups in an aqueous medium to form the network comprising crosslinked epoxy resin regions and crosslinked polysiloxane resin regions.

20. A primed substrate, comprising: a substrate having thereon an etch primer layer formed from the primer system of claim 1.

21. The primed substrate of claim 20, further comprising a primer layer formed on the etch primer layer, wherein the primer layer is formed from a waterborne polyurethane primer or a waterborne hybrid epoxy-polyurethane primer.

22. A method for priming a substrate, comprising: forming an etch primer layer on a surface of the substrate, wherein the etch primer layer is formed from the primer system according to claim 1.

23. The method of claim 22, further comprising forming a primer layer on the etch primer layer, wherein the primer layer is formed from a waterborne polyurethane primer or a waterborne hybrid epoxy-polyurethane primer.
